(19) United States
(12) Patent Application Publication
(10) Pub. No.: US 2025/0091655 A1
(43) Pub. Date: Mar. 20, 2025

(54) FRONT WALL FOR A MOTOR VEHICLE

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,443

(22) Filed: Sep. 13, 2024

(30) Foreign Application Priority Data
Sep. 14, 2023 (DE) 102023124890.1

(51) Int. Cl. B62D 25/08; B21D 53/88

(52) U.S. Cl. CPC B62D 25/082; B21D 53/88

(57) ABSTRACT

A front wall for a motor vehicle, which has a partition wall to an engine compartment located at the front in the longitudinal direction (x) of the motor vehicle, wherein the partition wall is oriented in the installed state in the vertical direction (z) of the motor vehicle and, connected to it in one piece, has a front region of a footwell metal sheet, wherein the footwell metal sheet runs at least in portions in the longitudinal direction (x) of the motor vehicle, the front wall being produced as a one-piece sheet-metal forming component, in particular in a single press stroke, characterized in that the footwell metal sheet has a greater wall thickness and/or tensile strength than the partition wall.

### RELATED APPLICATIONS

The present application claims priority of German Application Number 10 2023 124 890.1 filed Sep. 14, 2023, the disclosure of which is hereby incorporated by reference herein in its entirety.

### FIELD

The present disclosure relates to a front wall for a motor vehicle.

### BACKGROUND

Automobiles, able to be referred to as a motor vehicle, have an internal combustion engine. However, a motor vehicle is able to have an electric drive or an alternative energy source for operating the drive.

Such motor vehicles or automobiles have been manufactured for many years with a self-supporting body. Such a body is made of individual metal components, for example, steel components but also aluminum components, welded together. The individual components of the self-supporting body, for example the A-pillar, B-pillar, side member, cross member, bow, or also wheel arch or a front wall, also called a fire wall, as well as a footwell, are produced as individual press-formed components and then coupled to one another, for example, welded, so that the self-supporting body is assembled.

A front wall as a one-piece sheet metal component, manufactured in a hot forming process, is described in DE 10 2021 206 368 A1. Furthermore, the manufacture of a partially hot-formed and press-cured sheet metal component is described in EP 3 530 760 A1.

### SUMMARY

The object of the present disclosure is to demonstrate a way of providing in the underfloor region of the body, for example, in the front footwell region and in the region of the front wall, a component that is easy and cost-effective to manufacture, and is improved in terms of crash safety of the body and of passenger compartment safety.

The front wall for a motor vehicle, which has a partition wall to an engine compartment located at the front in the longitudinal direction of the motor vehicle, is characterized in that the partition wall, in the installed state, is arranged oriented in the vertical direction of the motor vehicle and also extends in the transverse direction of the motor vehicle. According to the present disclosure, a front region of a footwell metal sheet is connected to the front wall in one piece or is formed directly therewith. At least in portions, the footwell metal sheet is oriented in the longitudinal direction of the motor vehicle, for example, in a curved manner.

In the context of the present disclosure, the front wall is able to be regarded as forming a plane and the front region of the footwell metal sheet as a second plane, wherein both planes extend at an angle relative to each other and/or are connected to each other at an angle and/or via a curve.

Furthermore, according to the present disclosure, the front wall is able to be produced as a one-piece sheet metal forming component, for example, in a single press stroke, and, wherein, according to the present disclosure, the footwell metal sheet then has a thicker wall thickness and/or a higher tensile strength than the partition wall.

In the context of the present disclosure, “single-piece” means on one hand that is made from a single-piece sheet metal blank of a single material. However, a one-piece blank is able to be a tailor-welded blank that is welded together from different sheets. According to the present disclosure, however, the component is then formed in its entirety in a press, for example, in a single press stroke, or as a hot-formed and press-cured component. Thus, individual components are not formed separately from each other and then joined together later. This reduces production costs and helps to prevent corrosion at the joint. According to the present disclosure, a separate cross member is able to be dispensed with in the transition region from the front wall to the footwell metal sheet.

In at least one embodiment of the present disclosure, the wall thickness and/or tensile strength of two adjacent regions differ by more than 10%. However, in the context of the present disclosure, the tensile strength and/or wall thickness of two adjacent regions should not differ by more than 200%, and not by more than 100%.

Soft regions are able to be formed that have a tensile strength of less than 1000 MPa, less than 850 MPa. However, the soft regions should have a tensile strength Rm greater than 500 MPa. The soft regions have a carbon content (C content) of 0.06% to 0.13% by weight. In the following table, lines 7 and 8 are examples of steel alloys within these soft regions, provided that the regions result from the choice of material in a tailored welded blank. In at least one embodiment of the present discourse, high-strength regions with a tensile strength ≥1350 MPa, from one of the following steel alloys according to lines 3 to 6 of the table are able to be provided. However, strong regions with a tensile strength greater than 980 MPa, greater than 1100 MPa, are able to be formed. In at least one embodiment of the present discourse, ultra-high-strength regions with a tensile strength of ≥1100 MPa are able to be formed. Manganese-boron steels are able to be used for these regions. Furthermore, highest-strength regions with a tensile strength greater than 1850 MPa are able to be formed, for example, from an alloy according to one of lines 5 and 6 of the table.

In at least one embodiment of the present discourse, reinforcing patches are able to be applied locally to the sheet metal blank. These reinforcing patches are then also formed with the one press-forming tool, or with the one press stroke. There is no subsequent processing, such as in the form of subsequent coupling of further components, in order to produce this one described unit in the form of the front wall. The front wall is thus manufactured in a single piece in a press-forming process, which saves production costs. The patchwork sheet metal is also made of MnB steel, an alloy according to one of lines 3 to 6 of the table.

At the same time, the precision and accuracy of the component are able to be increased because the component is manufactured in a press-forming tool and then also calibrated accordingly. If, for example, the partition wall and the footwell metal sheet were manufactured separately, each component would possibly have to be precisely manufactured and calibrated on its own. However, if these are joined relative to each other after the actual forming process, this joined component is able to be recalibrated.

In order to improve rigidity and crash performance, a reinforcing bead is molded in one piece in a transition region between the partition wall and the footwell metal sheet. This reinforcing bead extends with its bead course oriented in the transverse direction of the motor vehicle. In cross-section, the bead, which is able to be C-shaped or U-shaped, is oriented in the longitudinal and/or vertical direction of the motor vehicle. In at least one embodiment of the present disclosure, the depth of the U-shaped bead is more than five times the sheet thickness of the component blank. In the case of a blank with different wall thicknesses or sheet thicknesses, the maximum sheet thickness is able to be selected as the starting point. The bead depth is then five times greater than this sheet thickness.

Thus, a forming geometry is able to be integrated in one region of the front wall and/or to increase the material thickness, i.e. the wall thickness, and/or to provide a higher tensile strength Rm, in such a way that the region of the forming geometry of the increased material thickness or higher strength takes on or has a cross member function. This eliminates the need for an external component to be coupled or installed as a cross member or reinforcing component. This measure increases the geometric accuracy to be achieved, improves crash performance and reduces production costs.

In at least one embodiment of the present disclosure, a forming geometry is able to be integrated in a region of the front wall and/or the wall thickness or material thickness is able to be increased and/or a higher tensile strength Rm is able to be provided, in such a way that the region has a longitudinal member function. In at least one embodiment of the present disclosure, the forming geometry is designed as a bead with regard to the longitudinal member function or cross member function. Longitudinal members and cross members are able to cross each other inside the front wall.

The one-piece production of the front wall with the partition and the front portion of the floor well allows the bead to be formed in, so that an additional reinforcing cross member, which would normally have to be used as an external component, is able to be dispensed with. The weight of the entire component is reduced. The additional cross member does not need to be manufactured, which reduces production costs. At the same time, the cross-sectional shape of the bead increases the rigidity of the entire component of the front wall, for example, due to its one-piece embodiment. In at least one embodiment of the present disclosure, the front wall has a higher strength in the region of the bead or in the bead itself, for example, greater than 1,000 MPa tensile strength Rm, or greater than 1,180 MPa tensile strength. The beads in the neighboring region of the front wall and footwell metal sheet are able to have different strengths.

The bead extends across the entire width of the front wall, and thus in the transverse direction of the motor vehicle.

In at least one embodiment of the present disclosure, a front longitudinal portion of a transmission tunnel is formed in the footwell metal sheet.

In at least one embodiment of the present disclosure, the respective outer regions of the footwell metal sheet, respectively with reference to the transverse direction of the motor vehicle, are partially spherical. Thus, a wheel arch or wheel house is able to be formed by the footwell metal sheet, at least in portions. Furthermore, the outer regions of the footwell metal sheet, with reference to the transverse direction of the motor vehicle, are designed to be soft. Such a soft region has a width of less than 100 mm in the transverse direction of the motor vehicle. This ensures that connection regions, for example of sills, a further wheel arch or similar, do not tear off due to the soft regions, for example, in the event of a crash. Here, targeted deformation takes place without fracture or tearing off of further components. This improves crash performance, with regard to the interior of the component of the front wall. The soft region should have a tensile strength between 500 MPa and 850 MPa.

### BRIEF DESCRIPTION OF THE DRAWINGS

Further advantages, features, characteristics and aspects of the present disclosure are the subject of the following description. Various embodiments are illustrated in schematic figures. These serve to facilitate an understanding of the present disclosure. In:

FIG. 1 shows a front wall according to at least one embodiment,

FIG. 2 shows a plan view and a cross-sectional view of the front wall at least one embodiment,

FIG. 3 shows an alternative embodiment variant to FIG. 2,

FIG. 4 shows an alternative embodiment variant,

FIG. 5 shows a schematic embodiment variant of the front wall.

### DETAILED DESCRIPTION

The same reference numerals are used in the figures for the same and similar components and also when a repeated description is omitted for reasons of simplification.

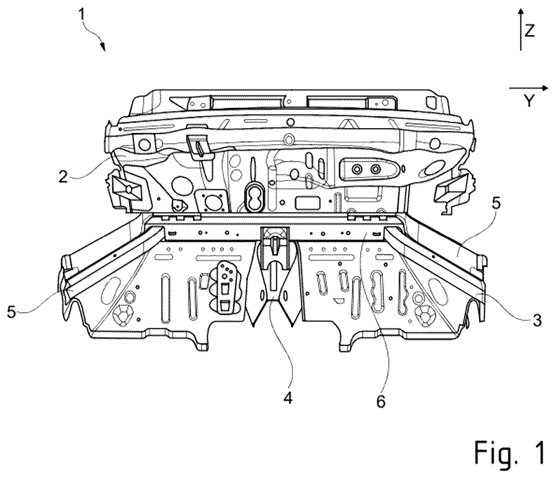

FIG. 1 shows a front wall 1 according to the present disclosure. This has a partition 2 that is oriented upwards in the vertical direction of the motor vehicle and a front section of a footwell metal sheet 3 that is arranged below in the vertical direction of the motor vehicle. According to the present disclosure, the partition 2 and footwell metal sheet 3 are one piece. In a central portion, a front longitudinal portion of a transmission tunnel 4 is formed in the footwell metal sheet 3. On the respective outer sides, partially spherical portions are formed in the footwell metal sheet 3. A wheel arch 5 is able to be arranged here. However, these outer portions, with respect to the transverse direction y of the motor vehicle, are able to be formed as a door sill connection.

In at least one embodiment, a bead 6 is formed between the partition 2 and the footwell metal sheet 3. The bead 6 extends over the entire width of the front wall 1. The bead is oriented in the transverse direction of the motor vehicle y. The bead 6 then has a deformation in cross section which is oriented in the longitudinal direction of the motor vehicle x and/or the vertical direction of the motor vehicle z, as shown for example in the figures below. A bulge of a U-shaped bead 6 is arranged oriented in the longitudinal direction of the motor vehicle x.

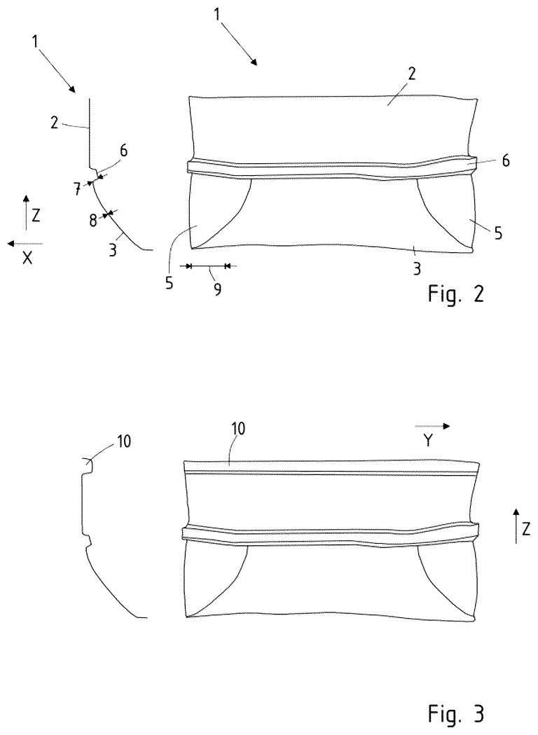

FIG. 2 shows a plan view and a cross-sectional view of the front wall 1. The partition wall 2 arranged at the top in the vertical direction of the motor vehicle is oriented vertically in the motor vehicle. The part of the footwell metal sheet 3 located below the footwell metal sheet 3 is slightly curved and oriented in the longitudinal direction of the motor vehicle x or, with reference to the direction of travel of the motor vehicle, is oriented against the longitudinal direction of the motor vehicle x. A bead 6 is formed between the two components. The bead 6 is U-shaped in cross-section. In at least one embodiment of the present disclosure, a depth 7 of the bead 6 is more than five times the wall thickness 8. The bead 6 is formed with a depth 7 larger than 30 mm, or larger than 40 mm. However, the bead 6 should not be designed with a depth 7 exceeding 200 mm.

In at least one embodiment of the present disclosure, outer regions in the form of wheel arch connections are formed on the footwell metal sheet 3. The outer regions have a width 9 that is less than 100 mm.

FIG. 3 shows an alternative embodiment to FIG. 2. In at least one embodiment of the present disclosure, a bead 10 located on the partition wall 2 in the direction of the vehicle vertical z is also molded in. This upper bead 10 is able to additionally reinforce or function as a lower window frame cross member of a window frame or roof support to be connected. This increases rigidity, for example, in the transverse direction of the vehicle.

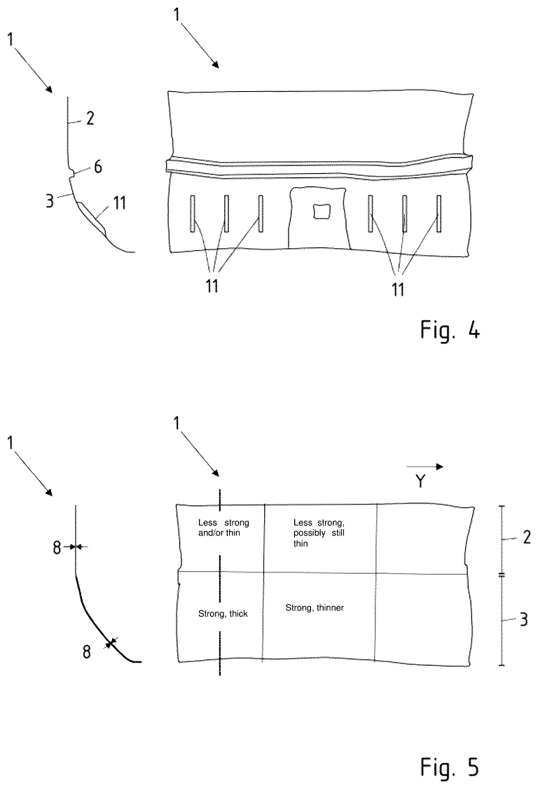

FIG. 4 shows an alternative embodiment variant. Here, a component patch is molded in. The component patch is molded in the region of a central region of the footwell metal sheet 3. In at least one embodiment of the present disclosure, longitudinal beads 11 are formed into the footwell metal sheet 3, which are able to serve for additional stiffening. The longitudinal beads 11, designed as an island, are able to be designed as continuous beads up to the lower edge of the footwell metal sheet 3. These are able to form a load path with further subsequently coupled longitudinal members.

FIG. 5 shows a schematic embodiment variant of the front wall 1. Here, regions are shown in the upper partition wall 2 and the lower footwell metal sheet 3, which are identified by a respective wall thickness 8 and/or strength. In at least one embodiment of the present disclosure, the wall thickness 8 of the footwell metal sheet 3 is greater than the wall thickness 8 of the partition wall 2. The respective strength ranges, which also vary in the transverse direction of the motor vehicle, are characterized in each case as strong or less strong. Less strong, according to the present disclosure, means 500 MPa to 1,000 MPa tensile strength. Strong means exceeding 1,000 MPa tensile strength. The schematic overview according to FIG. 5 is able to be applied to all embodiment variants of the present disclosure, for example, combined with the aforementioned exemplary embodiments of the bead 10. For manufacturing, a sheet metal blank or component blank is able to be used for production, which is produced as a tailor welded blank, i.e., a welded component, but which is also formed as a tailor rolled blank, i.e., a rolled blank. The entire front wall 1 with partition wall 2 and footwell metal sheet 3 is then formed in a press into a one-piece component.

The steel grades used are able to be used subsequently as examples and for all variants of present disclosure. In at least one embodiment of the present disclosure, different steel grades are able to be combined with each other in a tailored welded blank. The table shows the corresponding strength ranges for hard or soft regions or solid or ductile regions. All alloy components are given in percent by weight, with the respective curable steel alloy then being added to the residual iron and impurities caused by melting.

| 1 | TWB-Ab [symbol] chnitt | C | | Si | | Mn | | P | | S | | Al | | B | | Cr | |
|---|---|---|---|---|---|---|---|---|---|---|---|---|---|---|---|---|---|
| 2 | [symbol] us | min | max | min | max | min | max | min | max | min | max | min | max | min | max | min | max |
| 3 | [symbol] > | 0.19 | 0.25 | 0.1 | 0.4 | 1.1 | 1.4 | | 0.02 | | 0.005 | 0 | 0.06 | 0.001 | 0.005 | | 0.3 |
| | 1350 MPa | | | | | | | | | | | | | | | | |
| 4 | [symbol] | 0.2 | 0.23 | 0.2 | 0.3 | 1.1 | 1.4 | | 0.02 | | 0.006 | 0 | 0.06 | 0.002 | 0.004 | 0.1 | 0.3 |
| | 1500 MPa | | | | | | | | | | | | | | | | |
| 5 | [symbol] > | 0.31 | 0.37 | 0.1 | 0.6 | 1 | 1.5 | | 0.025 | | 0.02 | | 0.1 | 0.001 | 0.004 | 0.06 | 0.35 |
| | 1750 MPa | | | | | | | | | | | | | | | | |
| 6 | [symbol] | 0.33 | 0.35 | 0.15 | 0.35 | 1 | 1.5 | | 0.025 | | 0.015 | 0.01 | 0.08 | 0.001 | 0.004 | 0.06 | 0.5-Mo |
| | 1300 MPa | | | | | | | | | | | | | | | | |
| 7 | [symbol] > | 0.06 | 0.13 | | 0.7 | | 1.9 | | 0.05 | | 0.05 | | 0.1 | | 0.003 | | 0.15 |
| | 450 MPa | | | | | | | | | | | | | | | | |
| 8 | [symbol] | 0.07 | 0.11 | 0.02 | 0.6 | 1.2 | 1.8 | | 0.03 | | 0.01 | 0.01 | 0.07 | 0.0007 | 0.002 | | 0.15 |
| | [symbol] -1000 MPa | | | | | | | | | | | | | | | | |

| 1 | TWB-Ab [symbol] chnitt | Cu | | N | | Nb | | Ni | | Ti | | V | | Mo | |
|---|---|---|---|---|---|---|---|---|---|---|---|---|---|---|---|
| 2 | [symbol] us | min | max | min | max | min | max | min | max | min | max | min | max | min | max |
| 3 | [symbol] > | | 0.1 | | | | 0.05-Ti | 0.1 | 0.02 | 0.01 | 0.1 | | | | 0.35 |
| | 1350 MPa | | | | | | | | | | | | | | |
| 4 | [symbol] | | 0.1 | | 0.01 | | 0.05-Ti | 0.1 | 0.02 | 0.02 | 0.05 | | 0.01 | | 0.35 |
| | 1500 MPa | | | | | | | | | | | | | | |
| 5 | [symbol] > | | 0.2 | | 0.2 | | 0.1 | | 0.2 | 0.002 | 0.05 | | | | 0.35 |
| | 1750 MPa | | | | | | | | | | | | | | |
| 6 | [symbol] | | 0.2 | | 0.2 | 0.01 | 0.05 | | 0.2 | 0.005 | 0.015 | | 0.01 | | 0.5-Cr |
| | 1300 MPa | | | | | | | | | | | | | | |
| 7 | [symbol] > | | 0.2 | | 0.2 | | 0.1 | | | | 1.2 | | 0.1 | | 0.1 |
| | 450 MPa | | | | | | | | | | | | | | |
| 8 | [symbol] | | 0.2 | | 0.2 | 0.04 | 0.1 | | | 0.03 | 0.2 | | 0.1 | | 0.1 |
| | [symbol] -1000 MPa | | | | | | | | | | | | | | |

[symbol]

indicates data missing or illegible when filed

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations are able to be made hereto without departing from the spirit and scope of the disclosure.

1-13. (canceled)

14. A front wall for a motor vehicle, the front wall comprising:
a partition wall to an engine compartment located at a front in a longitudinal direction of the motor vehicle, wherein the partition wall, in an installed state, is oriented in a vertical direction of the motor vehicle; and
a footwell metal sheet, wherein the footwell metal sheet is oriented at least in portions in the longitudinal direction of the motor vehicle, and a front region of the footwell metal sheet is connected to the partition wall in one piece,
wherein the front wall is a one-piece sheet-metal forming component formed in a single press stroke,
wherein the footwell metal sheet has at least one of a greater wall thickness or a greater tensile strength than the partition wall,
wherein the front wall has
a high-strength region which has a tensile strength greater than or equal to 1350 MPa, and
a soft region which has a tensile strength of less than 1000 MPa,
wherein a bead extending in a transverse direction of the motor vehicle comprises a transition between the partition wall and the footwell metal sheet, and wherein the bead is formed in a cross section in at least one of the longitudinal direction (x) or the vertical direction of the motor vehicle.

15. The front wall according to claim 14, wherein as the one-piece sheet-metal forming component is a hot-formed and press-cured component.

16. The front wall according to claim 14, wherein a region of the front wall has at least one of a forming geometry integrated in the region, an increased material thickness or a higher strength, such that the region is configured to function as a cross member.

17. The front wall according to claim 14, wherein a region of the front wall has at least one of a forming geometry integrated in the region, an increased material thickness or a higher strength such that the region is configured to function as a longitudinal member.

18. The front wall according to claim 14, wherein the soft regions re has a tensile strength of less than 850 MPa.

19. The front wall according to claim 14, further comprising:
a reinforcing patch applied in a region of
the bead that extends in the transverse direction,
a central or outer longitudinal bead of the front wall, or
a wheel arch of the front wall.

20. The front wall according to claim 14, wherein the bead has a bead depth which corresponds to at least five times a wall thickness of a sheet-metal blank.

21. The front wall according to claim 14, wherein the tensile strength in a region of the bead is greater than 1,180 MPa.

22. The front wall according to claim 14, further comprising:
a patchwork metal sheet attached in a region of the bead, wherein the tensile strength in this region is greater than 980 MPa.

23. The front wall according to claim 14, wherein the footwell metal sheet is curved along multiple axes or in three dimensions on an outer side thereof in the transverse direction of the motor vehicle such that a wheel arch is formed at least in portions.

24. The front wall according to claim 14, wherein outer regions of the footwell metal sheet comprise a soft zone, with a tensile strength of less than 980 MPa, wherein and the outer regions have a width of less than 100 mm in the transverse direction of the motor vehicle.

25. The front wall according to claim 14, wherein the one-piece sheet-metal forming component comprises a coated steel component produced from a precoated steel alloy, wherein a precoating of the precoated steel alloy is an Al—Si coating, with a layer thickness between 15 and 40 μm.

26. The front wall according to claim 14, wherein the footwell metal sheet has a central tunnel with at least one central longitudinal bead and configuring a front longitudinal portion of a transmission tunnel.
